(19) United States
(12) Patent Application Publication
(10) Pub. No.: US 2009/0004530 A1
(43) Pub. Date: Jan. 1, 2009

(54) CONTROL VALVE WITH ENHANCED INNER SURFACE

(76) Inventors: Christian Koenig, Dreieich (DE); Ulrich Dumke, Eppstein (DE); Christian Preis, Hachborn (DE)

Correspondence Address: FRASER CLEMENS MARTIN & MILLER LLC, 28366 KENSINGTON LANE, PERRYSBURG, OH, 43551-4163, US

(21) Appl. No.: 11/770,438

(22) Filed: Jun. 28, 2007

(51) Int. Cl. H01M 8/02; F16K 1/22; F16K 27/02

(52) U.S. Cl. 429/34; 251/305; 251/368

(57) ABSTRACT

A control valve is disclosed having a passage formed therein defined by an inner surface, the control valve includes at least one enhanced surface, a liner, or a combination thereof to militate against ice formation thereon and adhesion of the ice thereto.

### FIELD OF THE INVENTION

The present invention relates to a fuel cell system and more particularly to a control valve for a fuel cell system having at least one enhanced surface to militate against ice formation and adhesion of ice thereto.

### BACKGROUND OF THE INVENTION

A fuel cell system is an electro-chemical device that includes an anode and a cathode with an electrolyte disposed therebetween. The anode receives a fuel such as hydrogen gas and the cathode receives an oxidant such as oxygen or air. When the hydrogen is supplied to a reaction plane of the anode, the hydrogen is ionized and the hydrogen ions are transferred to the cathode via a solid polymer electrolyte membrane. During this process, electrons are released and flow to an external circuit, providing DC (direct current) electric energy. As the air is supplied to the cathode, the hydrogen ions, electrons, and oxygen in the air react at the cathode and produce a humidified gas and water (wet gas). The wet gas is exhausted from the fuel cell system by means of a cathode exhaust conduit. Typically, not all of the water from the wet gas is exhausted from the cathode exhaust conduit.

Control valves, such as the two-position valve disclosed in commonly owned U.S. Pat. App. Pub. No. 20050186457, incorporated herein by reference in its entirety, are typically disposed in the cathode exhaust conduit and control a pressure within the fuel cell system. Under certain operating conditions, the wet gas condenses in the control valve. The condensate and the water from the wet gas remaining in the cathode exhaust conduit may freeze and form ice in and around the vicinity of the control valve. The ice may contact the moveable member of the control valve and prevent normal operation of the control valve. When the control valve is not functioning properly, it may be difficult to operate the fuel cell system, which is undesirable.

It would be desirable to produce a control valve for a fuel cell system, wherein the control valve includes at least one enhanced surface to militate against ice formation and adhesion of ice thereto, which is simple to manufacture and install.

### SUMMARY OF THE INVENTION

In concordance and agreement with the present invention, a control valve for a fuel cell having at least one enhanced surface to militate against ice formation and adhesion of ice thereto, which is simple to manufacture and install, has surprisingly been discovered.

In one embodiment, a valve assembly comprising a housing adapted to be disposed in a fuel cell system conduit, the housing having a passage formed therein defined by an inner surface; and a moveable member disposed in the housing and adapted to selectively permit and militate against a flow of fluid through the housing, wherein at least one of the inner surface and the moveable member includes an enhanced surface.

In another embodiment, a fuel cell valve comprising a housing adapted to be disposed in a conduit in fluid communication with a fuel cell stack, the housing having a passage formed therein defined by an inner surface; a moveable member disposed in the housing and adapted to selectively permit and militate against a flow of fluid through the passage; and an actuator provided to maneuver the moveable member, wherein at least one of the inner surface and the moveable member includes an enhanced surface.

In another embodiment, a valve assembly comprising a housing adapted to be disposed in a conduit, the housing having a passage formed therein; a moveable member disposed in the housing and adapted to selectively permit and militate against a flow of fluid through the passage; an actuator provided to maneuver the moveable member; and a liner adapted to be disposed in the passage formed in the housing, wherein the liner is produced from a hydrophobic material.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is an exploded perspective view of a prior art fuel cell system;

FIG. 2 is a schematic flow diagram of a fuel cell stack in accordance with an embodiment of the invention;

FIG. 3 is an end elevational view of a control valve assembly in accordance with an embodiment of the invention, wherein the control valve is a butterfly type multi-position valve;

FIG. 4 is a fragmentary sectional view along line 4-4 of the control valve illustrated in FIG. 3, wherein a moveable member is in a closed position;

FIG. 5 is a fragmentary sectional view of a control valve in accordance with another embodiment of the invention, wherein a moveable member is in a closed position and a liner is disposed therein; and

FIG. 6 is a prospective view of a moveable member of the control valve shown in FIGS. 3 thru 5.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

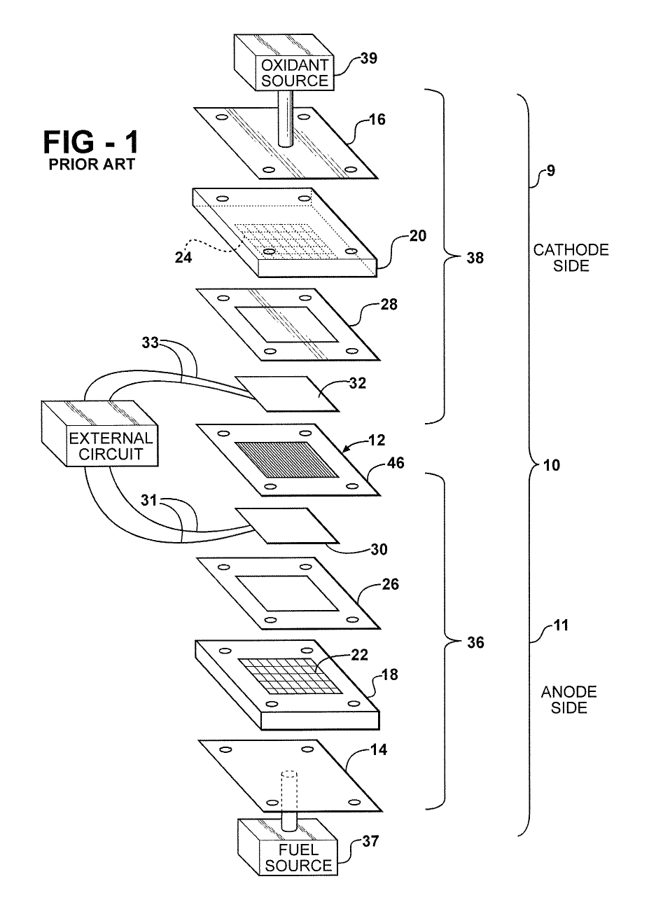

FIG. 1 shows a fuel cell 10 having a cathode side 9 and an anode side 11. The anode side 11, the cathode side 9, and a coolant system (not shown) are collectively referred to as a wet end of the fuel cell 10. Insulation end plates 14, 16 are referred to as a dry end of the fuel cell 10. The fuel cell 10 is in fluid communication with a fuel source 37 and an oxidant source 39. Graphite blocks 18, 20 having a plurality of openings 22, 24 to facilitate fluid distribution are disposed adjacent the insulation end plates 14, 16. Gaskets 26, 28 and carbon cloth current collectors 30, 32 having respective connections 31, 33, are respectively disposed between a membrane electrode assembly (MEA) 12 and the blocks 18, 20. A fuel and current transport means 36 is made up of the graphite block 18, the gasket 26, and the current collector 30. An oxidant and current transport means 38 is made up of the graphite block 20, the gasket 28, and the current collector 32. The anode connection 31 and the cathode connection 33 are used to interconnect the fuel cell 10 with an external circuit (not shown), and may include other fuel cells (not shown) as desired.

A fuel cell stack (not shown) is constructed of a plurality of fuel cells 10 connected in series. The fuel cell stack as described herein is commonly used as a power plant for the generation of electric power in a vehicle, for example.

In use, a fuel such as hydrogen, for example, is supplied from the fuel source 37 and an oxidant such as oxygen, for example, is supplied from the oxidant source 39. The fuel and oxidant from respective sources 37, 39 diffuse through respective fluid and current transport means 36, 38 to opposing sides of the MEA 12. Porous electrodes (not shown) form an anode (not shown) at the anode side 11 and a cathode (not shown) at the cathode side 9, and are separated by a proton exchange membrane (PEM) 46. The PEM 46 provides for ion transport to facilitate a chemical reaction in the fuel cell 10. Typically, the PEM 46 is produced from copolymers of suitable monomers. Such proton exchange membranes may be characterized by monomers of the structures:

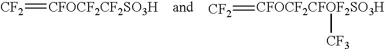

Such a monomer structure is disclosed in detail in U.S. Pat. No. 5,316,871 to Swarthirajan et al, incorporated herein by reference in its entirety.

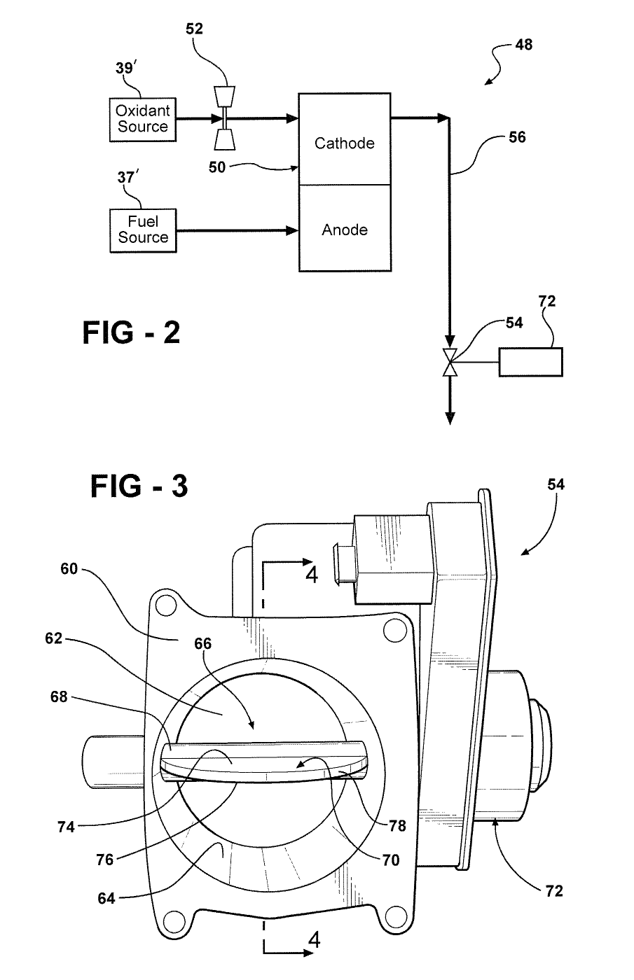

FIG. 2 shows a flow diagram of a fuel cell system 48 in accordance with an embodiment of the invention, wherein similar structure to that described above for FIG. 1 includes the same reference number followed by a prime (′) symbol. The fuel cell system 48 includes a fuel source 37′, an oxidant source 39′, a fuel cell stack 50 including one or more fuel cells (not shown) as described above for FIG. 1, a compressor 52 such as a turbo-compressor, for example, and a control valve 54. The fuel cell stack 50 and the control valve 54 are in fluid communication by means of a cathode exhaust conduit 56.

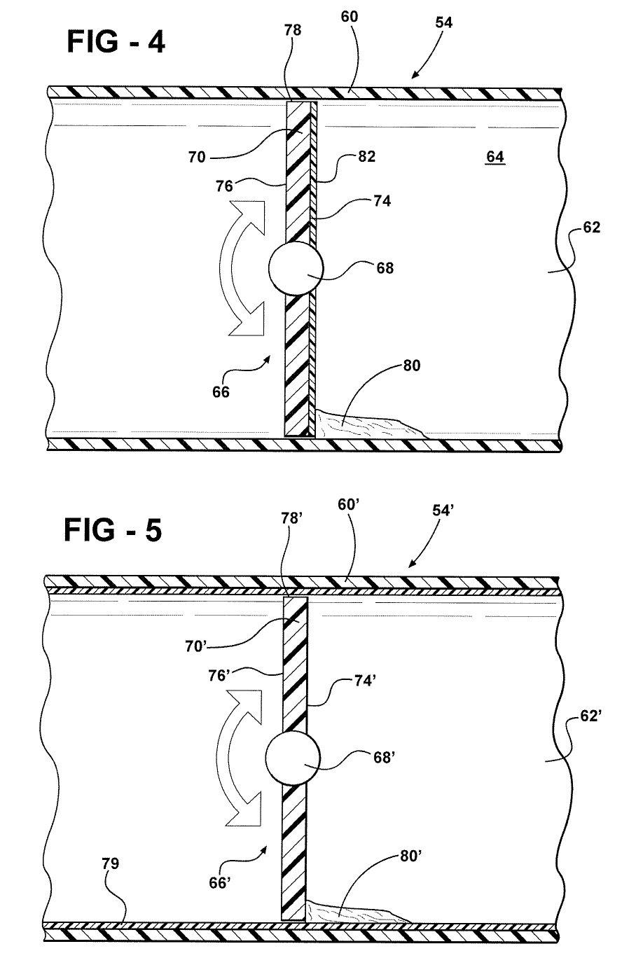

In the embodiment shown in FIGS. 3 and 4, the control valve 54 is a butterfly type multi-position valve. It is understood that other types of valves such as a ball valve, a globe valve, a gate valve, a flap valve, and a piston valve, for example, can be used as desired without departing from the scope and spirit of the invention. The control valve 54 is adapted to be disposed in the cathode exhaust conduit 56, and includes a valve housing 60 having a passage 62 formed therein defined by an inner surface 64. The inner surface 64 may be formed by the housing 60 or may be provided by a sleeve (not shown) received in a bore formed through the housing 60. It is understood that the valve housing 60 can be formed from any conventional material as is known in the art such as plastic and aluminum, for example.

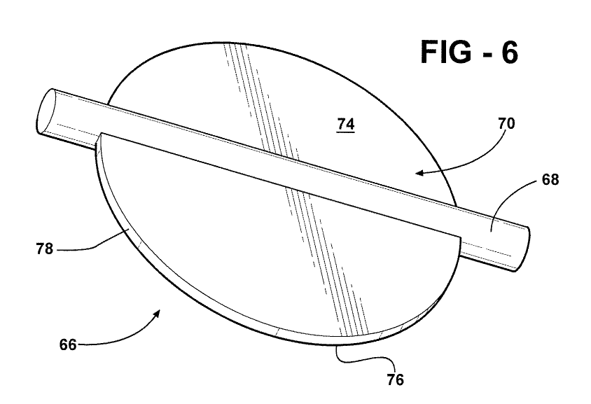

The control valve 54 includes a moveable member 66. The moveable member 66 is constructed and arranged to obstruct the passage 62 through the housing 60. An actuator 72 such as an electric motor, for example, may be operably connected to the control valve 54 to maneuver the moveable member 66 from an open position, as shown in FIG. 3, to a closed position, as shown in FIG. 4. It is understood that a controller (not shown) and instrumentation such as a temperature sensor (not shown), for example, can be provided for controlling the actuator 72. In the embodiment shown in FIGS. 3 and 4, the moveable member 66 is substantially disk shaped. The movable member includes a stem 68 adapted to be pivotally mounted to the valve housing 60 and a flange 70 extending laterally outwardly therefrom. FIG. 6 shows the moveable member 66 having a first face 74, a second face 76, and an outer edge 78. It is understood that the moveable member 66 can be formed from any conventional material as is known in the art such as plastic and aluminum, for example.

The control valve 54 includes an enhanced surface. As the term is used herein, the “enhanced surface” is a surface wherein the surface tension thereof is reduced and caused to be hydrophobic. The enhanced surface may be provided by any conventional means as is known in the art, such as mechanically or chemically treating, coating, or any combination thereof, for example. It is understood that mechanically treating may include processes such as sandblasting, shotpeening, milling, and grinding, for example, and chemically treating may include anodic oxidation, caustic treatments, or any combination thereof, for example. In the embodiment shown, a coating 82 comprising polytetrafluoroethylene (PTFE) is deposited on at least one of the surfaces 64, 74, 76, 78. The coating may comprise other materials known in the art including polyethylene, silicone, polypropylene, and nanoparticles, for example.

FIG. 5 depicts a control valve 54′ according to another embodiment of the invention. Reference numerals for similar structure in respect of the discussion of FIG. 4 above are repeated with a prime (′) symbol. The control valve 54′ is a butterfly type multi-position valve. It is understood that other types of valves such as a ball valve, a globe valve, a gate valve, a flap valve, and a piston valve, for example, can be used as desired without departing from the scope and spirit of the invention. The control valve 54′ is adapted to be disposed in the cathode exhaust conduit 56, and includes a valve housing 60′ having a passage 62′ formed therein. It is understood that the valve housing 60′ can be formed from any conventional material as is known in the art such as plastic and aluminum, for example.

The control valve 54′ includes a moveable member 66′. The moveable member 66′ is constructed and arranged to obstruct the passage 62′ through the housing 60′. An actuator 72 such as an electric motor, for example, may be operably connected to the control valve 54′ to maneuver the moveable member 66′ from an open position, (not shown), to a closed position, as shown in FIG. 5. It is understood that a controller (not shown) and instrumentation such as a temperature sensor (not shown), for example, can be provided for controlling the actuator 72. The moveable member 66′ is substantially disk shaped. The movable member includes a stem 68′ adapted to be pivotally mounted to the valve housing 60′ and a flange 70′ extending laterally outwardly therefrom. FIG. 6 shows the moveable member 66′ having a first face 74′, a second face 76′, and an outer edge 78′. It is understood that the moveable member 66′ can be formed from any conventional material as is known in the art such as plastic and aluminum, for example.

The control valve 54′ includes a liner 79 disposed in the valve housing 60′. In the embodiment shown, the liner 79 is produced from PTFE. It is understood that the liner 79 can be produced from other conventional materials having a low surface tension as desired.

In use, the fuel source 37′ provides a fuel such as hydrogen, for example, to the fuel cell stack 50 and the oxidant source 39′ provides an oxidant such as air, for example, to the fuel cell stack 50. Once in the fuel cell stack 50, a reaction between the oxidant and the fuel results in the creation of electrical energy. If the control valve 54, 54′ is in an open position, the moveable member 66, 66′ permits the flow of fluid through the control valve 54, 54′. As used herein, the term fluid can include gases, liquids, or any combination thereof. When in a closed position, the moveable member 66, 66′ militates against the flow of fluid through the control valve 54, 54′.

During operation of the fuel cell system 48, an amount of wet gas is produced as by-products of the reaction between the fuel and the oxidant. The wet gas is exhausted from the fuel cell system 48 by means of the cathode exhaust conduit 56. Typically, not all of the water from the wet gas produced by the reaction exits the fuel cell system 48 and under certain operating conditions, the wet gas may condense in the control valve 54, 54′. As shown in FIGS. 4 and 5, the water remaining in the cathode exhaust conduit 56 and the condensate may freeze and form ice 80, 80′ in the vicinity of the control valve 54, 54′. The ice 80, 80′ may contact the moveable member 66, 66′ of the control valve 54, 54′, and prevent an opening and a closing thereof.

At least one of the enhanced surfaces 64, 74, 74′, 76, 76′, 78, 78′, or liner 79, or any combination thereof militates against the formation of ice due to the hydrophobic nature thereof and the adhesion of ice by minimizing a surface tension thereof. The enhanced surfaces 64, 74, 74′, 76, 76′, 78, 78′, the liner 79, or any combination thereof cause water in the control valve 54, 54′ to be maintained in droplet form. A water droplet has less surface area in contact with the control valve 54, 54′, thereby reducing the amount of friction produced during the flow of the wet gas through the control valve 54, 54′. Furthermore, the enhanced surfaces 64, 74, 74′, 76, 76′, 78, 78′, the liner 79, or any combination thereof militate against a wetting of the surfaces 64, 74, 74′, 76, 76′, 78, 78′ of the control valve 54, 54′, resulting in a less conducive bonding surface for the water droplets. Accordingly, the reduction in friction and the drier surface minimize a force required to remove the water from the control valve 54, 54′.

The control valve 54, 54′ having at least one enhanced surface 64, 74, 74′, 76, 76′, 78, 78′, the liner 79, or combination thereof may be disposed in other conduits in the fuel cell system 48 such as recirculation gas stream lines, fuel inlet lines, and oxidant inlet lines, for example. The use of the control valve 54, 54′ is not limited to fuel cell applications. It is understood that the control valve 54, 54′ may be used in other application involving water and humidified gas streams as desired.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A valve assembly comprising:
a housing adapted to be disposed in a fuel cell system conduit, the housing having a passage formed therein defined by an inner surface; and
a moveable member disposed in the housing and adapted to selectively permit and militate against a flow of fluid through the housing, wherein at least one of the inner surface and the moveable member includes an enhanced surface.

2. The valve assembly according to claim 1, wherein the housing is disposed in a cathode exhaust conduit.

3. The valve assembly according to claim 1, further comprising an actuator to maneuver the moveable member.

4. The valve assembly according to claim 1, wherein the enhanced surface is achieved by at least one of a mechanical treating, a chemical treating, and applying a coating.

5. The valve assembly according to claim 4, wherein the mechanically treating includes at least one of sandblasting, shotpeening, milling, and grinding.

6. The valve assembly according to claim 4, wherein the chemically treating includes at least one of anodic oxidation and caustic treatment.

7. The valve assembly according to claim 4, wherein the applied coating includes at least one of polytetrafluoroethylene, wax, polyethylene, silicone, polypropylene, and nanoparticles.

8. The valve assembly according to claim 1, wherein the valve is a butterfly type valve.

9. A fuel cell valve comprising:
a housing adapted to be disposed in a conduit in fluid communication with a fuel cell stack, the housing having a passage formed therein defined by an inner surface;
a moveable member disposed in the housing and adapted to selectively permit and militate against a flow of fluid through the passage; and
an actuator provided to maneuver the moveable member, wherein at least one of the inner surface and the moveable member includes an enhanced surface.

10. The valve assembly according to claim 9, wherein the housing is disposed in a cathode exhaust conduit.

11. The valve assembly according to claim 9, wherein the enhanced surface is achieved by at least one of a mechanical treating, a chemical treating, and applying a coating.

12. The valve assembly according to claim 11, wherein the mechanical treating includes at least one of sandblasting, shotpeening, milling, and grinding.

13. The valve assembly according to claim 11, wherein the chemical treating includes at least one of anodic oxidation and caustic treatment.

14. The valve assembly according to claim 11, wherein the applied coating includes at least one of polytetrafluoroethylene, wax, polyethylene, silicone, polypropylene, and nanoparticles.

15. The valve assembly according to claim 9, wherein the valve is a butterfly type valve.

16. A valve assembly comprising:
a housing adapted to be disposed in a conduit, the housing having a passage formed therein;
a moveable member disposed in the housing and adapted to selectively permit and militate against a flow of fluid through the passage;
an actuator provided to maneuver the moveable member; and
a liner adapted to be disposed in the passage formed in the housing, wherein the liner is produced from a hydrophobic material.

17. The valve assembly according to claim 16, wherein the housing is disposed in a cathode exhaust conduit.

18. The valve assembly according to claim 16, wherein the moveable member includes an enhanced surface.

19. The valve assembly according to claim 16, wherein the liner is produced from at least one of polytetrafluoroethylene, polyethylene, silicone, and polypropylene.

20. The valve assembly according to claim 16, wherein the valve is a butterfly type valve.
